(19) United States
(12) Patent Application Publication
(10) Pub. No.: US 2012/0243835 A1
(43) Pub. Date: Sep. 27, 2012

(54) OPTICAL COUPLING ELEMENT AND METHOD OF MANUFACTURING THE SAME

(76) Inventors: Michihiko NISHIGAKI, Kawasaki-shi (JP); Hideto Furuyama, Yokohama-shi (JP)

(21) Appl. No.: 13/423,480

(22) Filed: Mar. 19, 2012

(30) Foreign Application Priority Data
Mar. 24, 2011 (JP) 2011-066184

(51) Int. Cl. G02B 6/36; B29C 65/52

(52) U.S. Cl. 385/88; 156/293

(57) ABSTRACT

According to one embodiment, an optical coupling element comprises an optical waveguide, a ferrule provided with a holding hole which holds the optical waveguide, electrical read frame formed on the element mounting surface of the ferrule, an optical semiconductor element which is mounted on the element mounting surface of the ferrule and connected to the electrical read frame, and a transparent adhesive which fills the gap between the optical semiconductor element and the optical waveguide. At least one side of the optical semiconductor element partially falls within a region obtained by extending the holding hole in the ferrule toward the optical semiconductor element.

### CROSS-REFERENCE TO RELATED APPLICATIONS

This application is based upon and claims the benefit of priority from prior Japanese Patent Application No. 2011-066184, filed Mar. 24, 2011, the entire contents of which are incorporated herein by reference.

### FIELD

Embodiments described herein relate generally to an optical coupling element and a method of manufacturing the same.

### BACKGROUND

In recent years, an optical coupling element which directly optically couples an optical semiconductor element mounted on a ferrule to an optical fiber positioned and held by the ferrule, without using an optical component such as a lens, has been proposed. In this optical coupling element, the gap between the optical fiber and the optical semiconductor element is filled with a transparent adhesive which serves to perform refractive index matching and fix the optical fiber to the ferrule.

However, if air bubbles are present in the transparent adhesive between the optical fiber and the optical semiconductor element, the optical coupling characteristics between the optical fiber and the optical semiconductor element change, compared to those in the absence of air bubbles. This varies the transmission characteristics in each individual manufactured element or in each individual channel for an element formed by arraying a plurality of channels. In other words, the reliability of the optical transmission characteristics degrades.

Also, a method of providing a resin reservoir on a connector which positions the optical fiber cannot directly optically couple the optical semiconductor element to the optical fiber, and leads to an increase in connector size.

### BRIEF DESCRIPTION OF THE DRAWINGS

FIG. 1 is a sectional view showing the schematic configuration of an optical coupling element according to the first embodiment;

FIG. 2 is a side view showing the schematic configuration of the optical coupling element according to the first embodiment;

FIG. 3 is a view showing the schematic surface structure of an optical semiconductor element when a VCSEL is used as the optical semiconductor element;

FIGS. 4A and 4B are sectional views showing the fact that air bubbles can be more reliably removed in the embodiment than in a Comparative Example;

FIGS. 5A and 5B are views for explaining how to define the size of an optical semiconductor element when a VCSEL is used as the optical semiconductor element;

FIGS. 6A and 6B are views for explaining how to define the size of an optical semiconductor element when a PD is used as the optical semiconductor element;

FIG. 7 is a side view showing the schematic configuration of an optical coupling element according to the second embodiment;

FIG. 8 is a sectional view showing the schematic configuration of an optical coupling element according to the third embodiment;

FIGS. 9A to 9C are sectional views showing steps in manufacturing an optical coupling element according to the fourth embodiment; and

FIGS. 10A and 10B are side views for explaining a Modification.

### DETAILED DESCRIPTION

In general, according to one embodiment, an optical coupling element comprises an optical waveguide, a ferrule provided with a holding hole which holds the optical waveguide, electrical read frame formed on the element mounting surface of the ferrule, an optical semiconductor element which is mounted on the element mounting surface of the ferrule and connected to the electrical read frame, and a transparent adhesive which fills the gap between the optical semiconductor element and the optical waveguide. At least one side of the optical semiconductor element partially falls within a region obtained by extending the holding hole in the ferrule toward the optical semiconductor element.

Embodiments will be described below with reference to the accompanying drawings.

In the following description of the drawings, the same or similar reference numerals denote the same or similar parts. However, note that the drawings show schematic configurations or methods, and the relationship between the thickness and the two-dimensional size and the ratio between the thicknesses of respective layers, for example, are different from those in practice. Therefore, specific thicknesses and sizes should be determined in consideration of the following description. Also, the drawings include parts having different relationships associated with the size and ratio between them, as a matter of course.

### First Embodiment

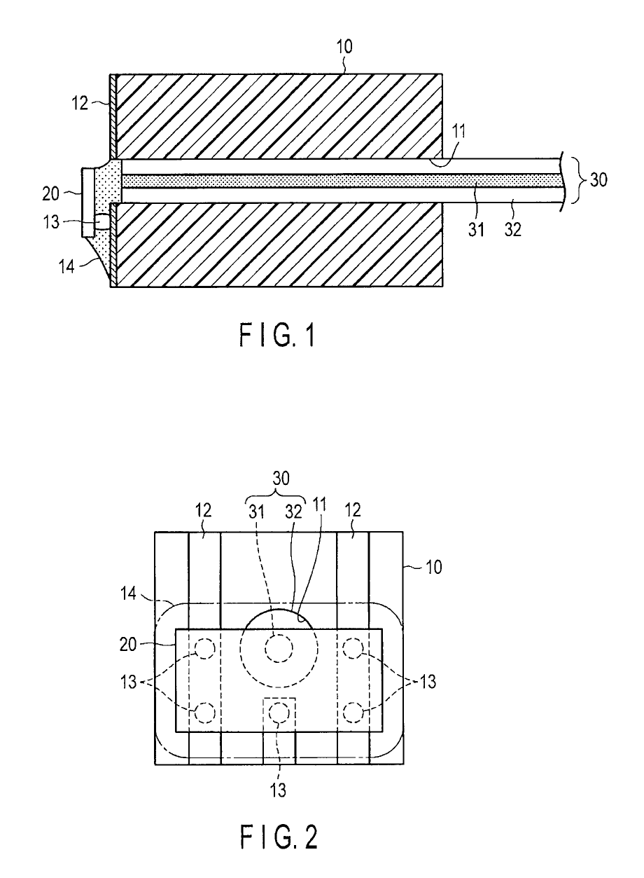

FIGS. 1 and 2 serve to explain the schematic configuration of an optical coupling element according to the first embodiment, in which FIG. 1 is a sectional view; and FIG. 2 is a side view.

The optical coupling element according to this embodiment includes, for example, an optical waveguide 30 for guiding a light wave, a ferrule 10 which holds and positions the optical waveguide 30 in a holding hole 11, electrical read frame 12 formed in the ferrule 10 by patterning, an optical semiconductor element 20 electrically connected to the electrical read frame 12 via bumps 13, and a transparent adhesive 14 which serves as an underfill material for the optical semiconductor element 20 and as a fixing material for the optical waveguide 30.

The ferrule 10 is made of epoxy resin mixed with a glass filler having a particle size of about 30 μm at about 80 percent, and is formed by resin molding which uses a metal mold. The holding hole 11 formed in the ferrule 10 has almost the same circular shape as the outer shape of the optical waveguide 30. The holding hole 11 holds and positions the optical waveguide 30. Note that the holding hole 11 need not always have the same shape over the entire length in the direction in which the optical waveguide 30 is inserted into the ferrule 10. The holding hole 11 may have almost the same shape as the outer shape of the optical waveguide 30 only in a portion required to position the optical waveguide 30. Also, although the optical waveguide 30 is inserted into the holding hole 11 with no gap between them in FIGS. 1 and 2, it may be inserted into the holding hole 11 with a gap between them.

The electrical read frame 12 is formed on one surface of the ferrule 10, that is, the element mounting surface of the ferrule 10, in which one opening of the holding hole 11 is formed, by pattern metallization using, for example, a metal mask and sputtering. This makes it possible to produce a large number of ferrules 10 equipped with electrical wiring at very low cost and very high accuracy of the order of one micrometer or less. Although the electrical read frame 12 is formed only on the element mounting surface of the ferrule 10 in FIG. 1, the present invention is not particularly limited to this. That is, the electrical read frame 12 may be formed across other surfaces (for example, the upper and lower surfaces in FIG. 1) of the ferrule 10 in consideration of mounting of the ferrule 10 on, for example, other substrates.

As the material of the ferrule 10, a resin obtained by mixing a glass filter not only in the above-mentioned epoxy resin but also in polyphenylene sulfide (PPS), liquid crystal polymer (LCP), polyamide resin, silicone resin, acryl resin, or polycarbonate resin can also be used. Various materials and connection methods such as a solder bump (hot melting), an Au bump (thermocompression bonding), an Sn/Cu bump (solid-phase welding) can be used for each bump 13 for mounting an optical element.

The optical semiconductor element 20 is, for example, a light-emitting element or a light-receiving element and can use, for example, a vertical cavity surface-emitting laser (VCSEL) or a photodiode (PD).

The optical waveguide 30 is an optical fiber formed by covering a core 31 with a cladding 32, and can use, for example, a quartz multimode graded-index (GI) fiber (core diameter=50 μm, cladding diameter=125 μm, and NA=0.21). Such an optical waveguide 30 has almost no frequency dependence of loss at frequencies of 100 GHz or more from the DC frequency, and therefore suffers neither electromagnetic interference nor ground potential fluctuation noise. This makes it possible to easily attain a transmission rate of several tens of gigabits per second. As the optical waveguide 30, a multicomponent glass optical fiber or a plastic optical fiber can also be used.

The end face of the optical waveguide 30 may be perpendicular or non-perpendicular to the optical waveguide direction of the optical waveguide 30, and formed into a desired end face shape by, for example, a fiber cleaver and polishing. In addition, the end face of the optical waveguide 30 may be shaped by cutting which uses a knife or a laser, etching which uses a chemical agent such as hydrofluoric acid, or hot plate shaping.

Also, although the surface of the ferrule 10, on which the optical semiconductor element 20 is mounted (the mounting surface for the optical semiconductor element 20) is perpendicular to the optical waveguide direction of the optical waveguide 30 in FIG. 1, the present invention is not particularly limited to this. To reduce returned light noise produced when light reflected by the end face of the optical waveguide 30 couples to the optical resonance mode of the VCSEL, the surface of the ferrule 10, on which the optical semiconductor element 20 is mounted, may be tilted with respect to the optical waveguide direction of the optical waveguide 30.

FIG. 2 shows the optical coupling element, shown in FIG. 1, when viewed from the side of the optical semiconductor element 20. The optical semiconductor element 20 is connected to the electrical read frame 12 via five bumps 13. One side of the optical semiconductor element 20 partially falls within a region (to be referred to as the extended region of the holding hole 11 hereinafter) obtained by extending the holding hole 11 in the ferrule 10 toward the optical semiconductor element 20. With this arrangement, part of the holding hole 11 has a portion which is not opposed to the optical semiconductor element 20, that is, the holding hole 11 has a portion which is not covered with the optical semiconductor element 20 when viewed from the side of the optical semiconductor element 20.

If a gap is present between the holding hole 11 and the optical waveguide 30, that is, between the holding hole 11 and the cladding 32 as well, the optical semiconductor element 20 need only be placed so that one side of the optical semiconductor element 20 partially falls within the extended region of the holding hole 11 in the ferrule 10.

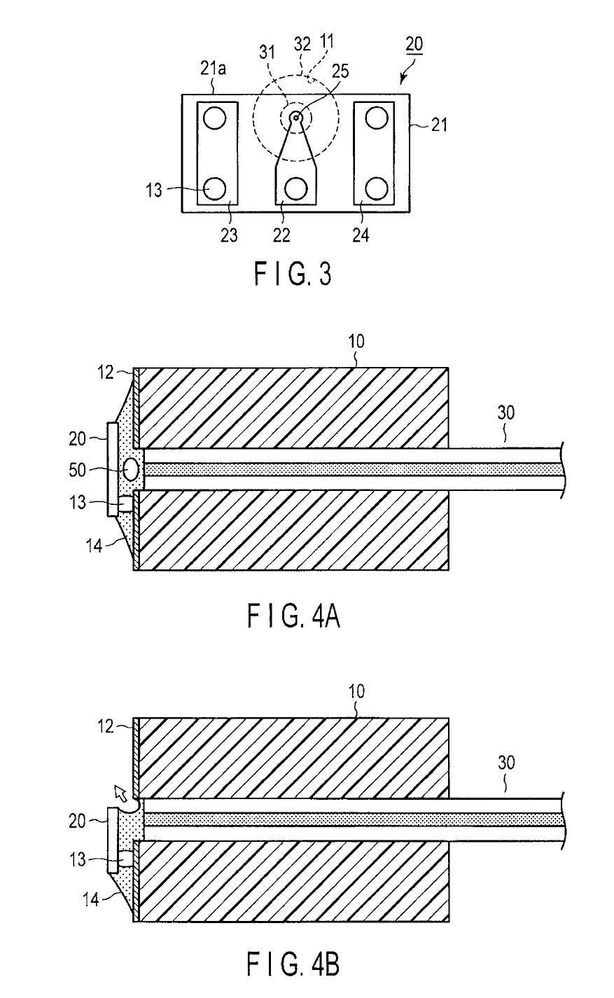

FIG. 3 shows the schematic surface structure of the optical semiconductor element 20 when a VCSEL is used as the optical semiconductor element 20. The optical semiconductor element 20 is manufactured by forming an anode electrode 22, cathode electrodes 23 and 24, and a laser oscillation region (not shown) on a substrate 21. Laser light is emitted via a laser exit aperture 25. Also, the laser exit aperture 25 is formed at almost the center of the core 31 of the optical waveguide 30. That is, the laser exit aperture 25 is formed at almost the centers of both the optical waveguide 30 and holding hole 11. Although a VCSEL has been illustrated herein, the same applies to a PD. Also, the anode electrode 22 and cathode electrodes 23 and 24 of the optical semiconductor element 20 can have arbitrary shapes.

As the procedure of manufacturing an optical coupling element according to this embodiment, first, gold bumps 13 are formed on an anode electrode 22 and cathode electrodes 23 and 24 of an optical semiconductor element 20. The gold bumps 13 are bonded to an electrical read frame 12 of a ferrule 10 by thermocompression to mount the optical semiconductor element 20 on the element mounting surface of the ferrule 10. The holding hole 11 in the ferrule 10 is filled with a sufficiently deaerated transparent adhesive 14, and the optical waveguide 30 is inserted into the holding hole 11 up to a predetermined position. Lastly, the transparent adhesive 14 is thermally cured so that the optical semiconductor element 20 is positioned and fixed on the ferrule 10.

In this case, to fill the holding hole 11 with the transparent adhesive 14, two types of methods are available. As the first method, the holding hole 11 is filled with the transparent adhesive 14 from the opening into which the optical waveguide 30 is inserted (a method of inserting the optical waveguide 30 from the right side of the ferrule 10 in FIG. 1). As the second method, the holding hole 11 is filled with the transparent adhesive 14 from the mounting surface for the optical semiconductor element 20 (a method of inserting the optical waveguide 30 from the left side of the ferrule 10 in FIG. 1).

When the holding hole 11 is filled with the transparent adhesive 14 from the opening into which the optical waveguide 30 is inserted, the transparent adhesive 14 reaches another end of the holding hole 11, that is, the mounting surface for the optical semiconductor element 20 by capillary action. Note that the transparent adhesive 14 does not adhere to the optical semiconductor element 20 at this time. Upon insertion of the optical waveguide 30, the transparent adhesive 14 is pushed out of the holding hole 11, thereby adhering to the optical semiconductor element 20.

On the other hand, when the holding hole 11 is filled with the transparent adhesive 14 from the mounting surface for the optical semiconductor element 20, the transparent adhesive 14 spreads between the optical semiconductor element 20 and the element mounting surface of the ferrule 10 by capillary action, that is, underfills the holding hole 11. The transparent adhesive 14 then penetrates through the holding hole 11 by capillarity and reaches the opening into which the optical waveguide 30 is inserted.

In the former filling method, when the transparent adhesive 14 overflows from the holding hole 11 and adheres to the optical semiconductor element 20 upon insertion of the optical waveguide 30, air bubbles 50 may be produced. As shown in FIG. 4A, in a structure in which the optical semiconductor element 20 completely covers the holding hole 11 according to a Comparative Example, the air bubbles 50 may remain between the optical waveguide 30 and the optical semiconductor element 20 even if the optical waveguide 30 is more deeply inserted into the holding hole 11.

If air bubbles 50 are present between the optical semiconductor element 20 and the core 31 of the optical waveguide 30, they lead to degradation in optical coupling characteristics. Hence, it is necessary to remove the air bubbles 50 between the core 31 and the optical semiconductor element 20. To do this, air bubbles 50 between the optical waveguide 30 and the optical semiconductor element 20 are preferably removed as much as possible.

On the other hand, in the latter filling method, if the transparent adhesive 14 spreads with a given distribution, it traps external air, so air bubbles 50 are produced. In this case as well, as shown in FIG. 4A, in a structure in which the optical semiconductor element 20 completely covers the holding hole 11 according to the Comparative Example, the air bubbles 50 may remain between the optical waveguide 30 and the optical semiconductor element 20 even if the optical waveguide 30 is more deeply inserted into the holding hole 11.

To prevent such air bubbles from being produced and remaining, one side 21a of the substrate 21 of the optical semiconductor element 20 is positioned to partially fall within the extension region of the holding hole 11 in this embodiment, as shown in FIG. 4B. With such an arrangement, in the former filling method, the transparent adhesive 14 which overflows from the periphery of the holding hole 11 upon insertion of the optical waveguide 30 adheres only to the portion of the holding hole 11, which is opposed to the optical semiconductor element 20, and does not adhere to the portion of the holding hole 11, which is not opposed to the optical semiconductor element 20. Hence, even if air bubbles 50 are produced, they are discharged outside from the portion of the holding hole 11, which is not opposed to the optical semiconductor element 20, as the optical waveguide 30 is inserted more deeply, as shown in FIG. 4B.

The air bubbles 50 are discharged toward one side (the side 21a in FIG. 3) of the optical semiconductor element 20, which partially falls within the extension region of the holding hole 11 in the ferrule 10. The air bubbles 50 are less likely to remain between the optical waveguide 30 and the optical semiconductor element 20, and are, in turn, less likely to remain between the light-receiving region or light-emitting region of the optical semiconductor element 20 and the core 31 of the optical waveguide 30. This makes it possible to effectively prevent any air bubbles 50 from remaining between the optical semiconductor element 20 and the optical waveguide 30.

In the latter filling method as well, the air bubbles 50 produced during filling are discharged outside from the portion of the holding hole 11, which is not opposed to the optical semiconductor element 20, as the optical waveguide 30 is inserted more deeply. This makes it possible to prevent any air bubbles 50 from remaining between the optical semiconductor element 20 and the optical waveguide 30.

The specific size of the portion of the holding hole 11, which is not opposed to the optical semiconductor element 20, is defined as follows.

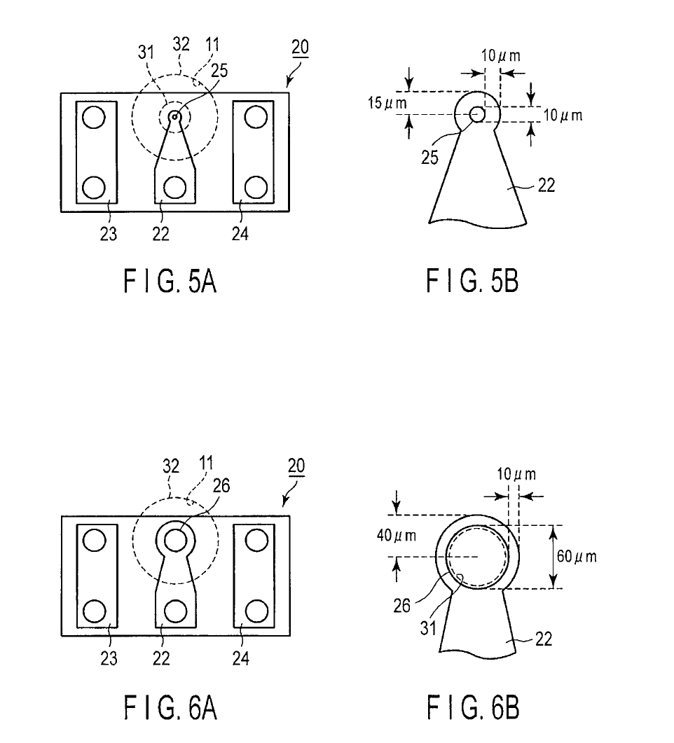

FIGS. 5A and 5B show the schematic surface structure of the optical semiconductor element 20 when a VCSEL is used as the optical semiconductor element 20. FIG. 5A shows the entire configuration, and FIG. 5B shows an enlarged view of the configuration of the main part. In this case, the diameter of the laser exit aperture 25 is 10 μm, and the core diameter of the optical waveguide 30 is 50 μm. Further, the width of the anode electrode 22 portion which surrounds the laser exit aperture 25 is 10 μm. At this time, the distance from the center of the laser exit aperture 25 to the anode electrode 22 portion which surrounds the laser exit aperture 25 is 15 μm. Therefore, one side 21a of the substrate 21 of the optical semiconductor element 20 can be brought to a position as close as 15 μm from the center of the laser exit aperture 25. In this case, one side 21a of the optical semiconductor element 20 partially falls within the extension region of the holding hole 11, so the holding hole 11 is not partially opposed to the optical semiconductor element 20.

Note that the actual distance from the center of the laser exit aperture 25 to the anode electrode 22 portion which surrounds the laser exit aperture 25 is desirably set so as to leave a margin with which the optical semiconductor element 20 is chipped by, for example, dicing. Moreover, the distance from one side 21a of the substrate 21 to the center of the laser exit aperture 25 is desirably set so as to leave a margin to the degree that the end of the anode electrode 22 does not come into contact with one side 21a.

FIGS. 6A and 6B show the schematic surface structure of the optical semiconductor element 20 when a PD is used as the optical semiconductor element 20. FIG. 6A shows the entire configuration, and FIG. 6B shows an enlarged view of the configuration of the main part. Reference numeral 26 denotes herein a light-receiving surface. The diameter of the light-receiving surface 26 is 60 μm, which is larger than the core 31 so that the light-receiving surface 26 can effectively receive light from the core 31 of the optical waveguide 30. Moreover, the width of the anode electrode 22 portion which surrounds the light-receiving surface 26 is 10 μm. As in the case of a VCSEL, when the center of the light-receiving surface 26 is set at almost the center of the holding hole 11, one side 21a of the substrate 21 of the optical semiconductor element 20 can be brought to a position as close as 40 μm from the center of the light-receiving surface 26. In this case, the portion of the holding hole 11, which is not opposed to the optical semiconductor element 20, can be formed most widely.

In addition to preventing any air bubbles 50 from remaining between the optical semiconductor element 20 and the optical waveguide 30 in this way, the following effect can also be obtained. That is, the size of the substrate 21 of the optical semiconductor element 20 can be reduced by bringing one side 21a of the substrate 21 of the optical semiconductor element 20 close to the laser exit aperture 25 or light-receiving surface 26. This also makes it possible to lower the manufacturing cost of the optical semiconductor element 20.

Although two types of ferrules 10 may be independently provided for a VCSEL and a PD, the same ferrule 10 can be used when the VCSEL and the PD have the same electrode pattern. Hence, from the viewpoint of reducing the manufacturing cost of an optical coupling element, the VCSEL and the PD desirably have the same electrode pattern.

As described above, according to this embodiment, one side 21a of the optical semiconductor element 20 partially falls within the extension region of the holding hole 11 in the ferrule 10. This makes it possible to easily discharge any air bubbles 50 produced in the gap between the optical semiconductor element 20 and the optical waveguide 30 from the holding hole 11 in the ferrule 10 and the region of the holding hole 11, which is not opposed to the optical semiconductor element 20. This, in turn, makes it possible to improve the reliability of the optical coupling characteristics between the optical semiconductor element 20 and the optical waveguide 30. In addition, the method according to this embodiment does not increase the size of the ferrule 10, unlike a method of providing a resin reservoir or a path in the ferrule 10 to discharge air bubbles. This is remarkably effective in reducing the manufacturing cost.

### Second Embodiment

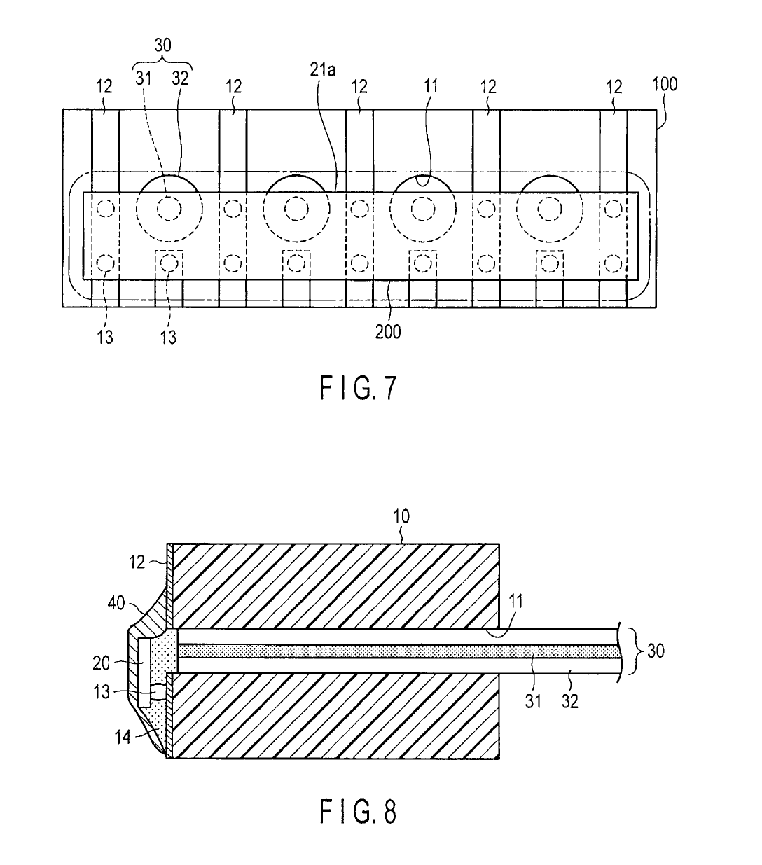

FIG. 7 is a side view for explaining the schematic configuration of an optical coupling element according to the second embodiment when viewed from the side of an optical semiconductor element.

This embodiment relates to arrayed optical waveguides 30. As in the first embodiment, one side 21a of a substrate 21 of an optical semiconductor element 200 partially falls within the extension region of each holding hole 11.

More specifically, a plurality of holding holes 11 are formed in a ferrule 100 to align themselves in one direction, and the arrayed optical waveguides 30 are inserted into the holding holes 11, respectively. The optical semiconductor element 200 is formed by arraying VCSELs in one direction, and the distance between the VCSELs is equal to that between the holding holes 11. The optical semiconductor element 200 is mounted across the plurality of holding holes 11 so that one side 21a of the optical semiconductor element 200 in the longitudinal direction partially falls within the extension region of each holding hole 11.

Note that when the arrayed optical waveguides 30 are larger in number than the holding holes 11 in one ferrule 100, a plurality of ferrules can be used. Also, the optical semiconductor element 200 is not particularly limited to VCSELs, and may use PDs.

As in this embodiment, when the plurality of holding holes 11 are adjacent to each other, the optical waveguides 30 cannot always be inserted into the individual holding holes 11 at exactly the same timing, and they may be inserted at slightly different timings. When, for example, the optical waveguides 30 are inserted into holding holes B on the two sides of holding hole A at a timing earlier than that at which the optical waveguide 30 is inserted into holding hole A, a transparent adhesive 14 may enter the portion corresponding to holding hole A from its vicinity, thus producing air bubbles 50. When, for example, the holding holes 11 are filled with the transparent adhesive 14 from the side from which the optical waveguides 30 are inserted, the transparent adhesive 14 overflows from holding holes B around holding hole A upon the insertion of the optical waveguide 30. When the transparent adhesive 14 overflows from holding holes B, it adheres to the optical semiconductor element 200 earlier in the vicinity of the periphery of holding hole A than in the vicinity of the center of holding hole A. When the transparent adhesive 14 further overflows as the optical waveguide 30 is inserted more deeply, the adhesive portions on the two sides of the portion corresponding to holding hole A come into contact with each other. At this time, air bubbles 50 are produced.

In a structure in which the optical semiconductor element 20 completely covers the holding holes 11, as in the above-mentioned structure shown in FIG. 4A, the air bubbles 50 produced once are more likely to stay between the optical waveguides 30 and the optical semiconductor element 200 even if the optical waveguide 30 is inserted into holding hole A. When the air bubbles 50 remain between the optical waveguides 30 and the optical semiconductor element 200, they lead to changes in transmission characteristics. Especially in an element formed by arraying a plurality of channels, the transmission characteristics vary in each individual channel, thus considerably degrading the reliability of the optical transmission characteristics.

In contrast to this, in this embodiment, because one side of the optical semiconductor element 200 partially falls within the extension region of each holding hole 11, any air bubbles 50 can be discharged outside from the portion of the holding hole 11, which is not opposed to the optical semiconductor element 20, as the optical waveguides 30 are inserted more deeply. This makes it possible to prevent any air bubbles 50 from remaining between the optical waveguides 30 and the optical semiconductor element 200. This, in turn, makes it possible to make uniform the transmission characteristics of the individual channels.

As described above, according to this embodiment, since one side 21a of the optical semiconductor element 200 in the longitudinal direction partially falls within the extension region of each holding hole 11, it is possible to prevent any air bubbles from remaining between the optical semiconductor element 200 and the optical waveguides 30, as in the first embodiment. Hence, the same effect as in the first embodiment can be obtained.

### Third Embodiment

FIG. 8 is a sectional view showing the schematic configuration of an optical coupling element according to the third embodiment.

In the optical coupling element according to this embodiment, a transparent adhesive 14 at a position at which a holding hole 11 in a ferrule 10 is not opposed to an optical semiconductor element 20, as in the optical coupling element according to the first embodiment, is covered with an opaque resin 40.

When the opaque resin 40 is not applied, external light enters the optical coupling element from the region in which an optical waveguide 30 is not opposed to the optical semiconductor element 20, and results in noise in the optical semiconductor element 20. Hence, the transparent adhesive 14 at least at a position at which the holding hole 11 in the ferrule 10 is not opposed to the optical semiconductor element 20 is covered with the opaque resin 40. This makes it possible to prevent most of external light from entering the optical coupling element.

As described above, according to this embodiment, it is possible not only to obtain the effect as in the first embodiment but also to prevent external light from entering the optical coupling element. To more reliably prevent external light from entering the optical coupling element, the opaque resin 40 may be applied onto the transparent adhesive 14 so as to cover the entire transparent adhesive 14.

### Fourth Embodiment

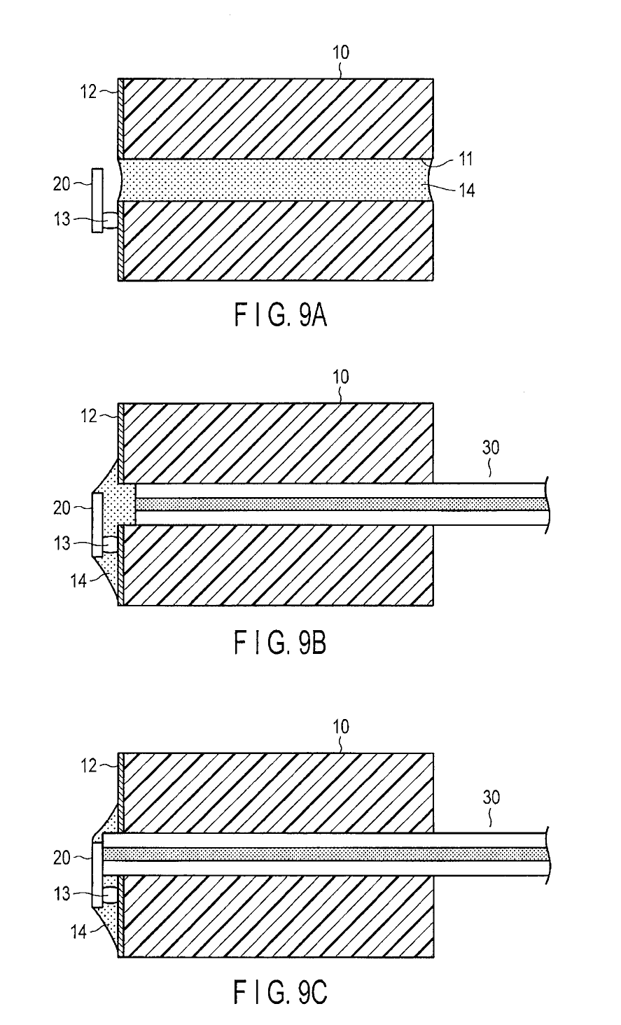

FIGS. 9A to 9C are sectional views showing steps in manufacturing an optical coupling element according to the fourth embodiment. This embodiment relates to a method of manufacturing the above-mentioned optical coupling element shown in FIG. 1.

As described in the first embodiment, bumps 13 are formed on an anode electrode 22 and cathode electrodes 23 and 24 of an optical semiconductor element 20, and bonded to an electrical read frame 12 of a ferrule 10 by thermocompression. Upon this operation, the optical semiconductor element 20 is mounted on the element mounting surface of the ferrule 10. A holding hole 11 in the ferrule 10 is filled with a sufficiently deaerated transparent adhesive 14, as shown in FIG. 9A. As a method of filling the holding hole 11 with the transparent adhesive 14, a method of filling the holding hole 11 from the opening into which an optical waveguide 30 is inserted is adopted.

Note that the bumps 13 need not always be connected to the electrical read frame 12 by thermocompression bonding, and need only be fixed on the electrical read frame 12 sufficiently tightly. Further, bumps may be formed on the electrical read frame 12 instead of forming them on the cathode electrodes 23 and 24.

The optical waveguide 30 is inserted into the holding hole 11 in the ferrule 10, as shown in FIG. 9B. Upon the insertion of the optical waveguide 30, the transparent adhesive 14 overflows from the holding hole 11 and comes into contact with the optical semiconductor element 20.

The optical waveguide 30 is temporarily brought into contact with the optical semiconductor element 20 so that any air bubbles are reliably discharged, as shown in FIG. 9C. The optical waveguide 30 is retracted to a predetermined position, thereby completing the above-mentioned structure shown in FIG. 1.

With the above-mentioned manufacturing method, even if air bubbles are produced in the gap between the optical waveguide 30 and the optical semiconductor element 20, they are reliably discharged to the region, in which the holding hole 11 in the ferrule 10 is not opposed to the optical semiconductor element 20, by inserting the optical waveguide 30 until it comes into contact with the optical semiconductor element 20. This makes it possible to prevent any air bubbles from remaining between the optical waveguide 30 and the optical semiconductor element 20.

Note that in moving the optical waveguide 30 to a predetermined position from the state in which it is kept in contact with the optical semiconductor element 20, external air may be trapped in the gap between the optical waveguide 30 and the optical semiconductor element 20 from the region in which the holding hole 11 in the ferrule 10 is not opposed to the optical semiconductor element 20. That is, air bubbles may be produced in the gap between the optical waveguide 30 and the optical semiconductor element 20. To prevent this, an additional transparent adhesive is further applied so as to cover the transparent adhesive 14 while the optical waveguide 30 is kept in contact with the optical semiconductor element 20, as shown in FIG. 9C. This makes it possible to increase the distance between the external air and the region in which the holding hole 11 in the ferrule 10 is not opposed to the optical semiconductor element 20, thereby reliably preventing the external air from being trapped.

### Modification

Note that the present invention is not particularly limited to each of the above-mentioned embodiments.

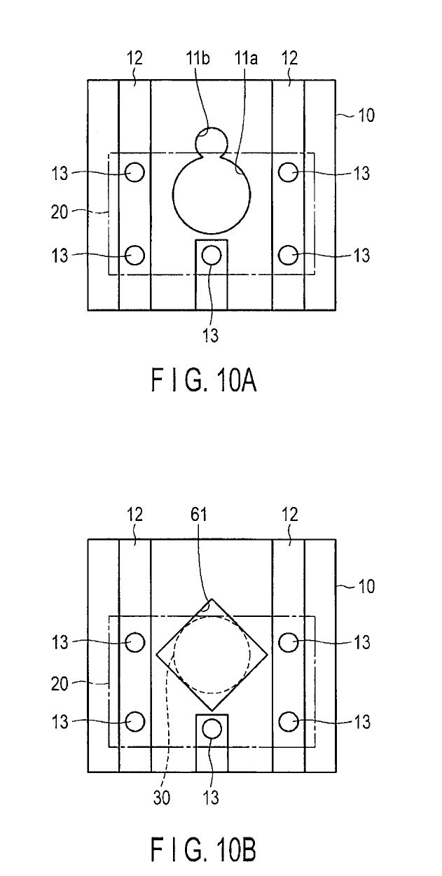

A holding hole corresponding to one optical waveguide need not always be formed by one hole. As shown in, for example, FIG. 10A, a holding hole corresponding to one optical waveguide may be formed by a holding hole 11a in which this optical waveguide is held and fixed, and an auxiliary hole 11b connected to the holding hole 11a. In this case, as long as the auxiliary hole 11b partially falls outside the optical semiconductor element 20, an air bubble removal effect can be obtained. Further, not only the auxiliary hole 11b but also the holding hole 11a may partially fall outside the optical semiconductor element 20.

Also, the holding hole need not always be circular, and a square hole 61 with a side nearly equal to the diameter of the optical waveguide may be used instead, as shown in FIG. 10B. When one of the corners of the square hole 61 falls outside the optical semiconductor element 20, it is possible not only to obtain an air bubble removal effect but also to further reduce the size of the ferrule.

Moreover, although the optical waveguide 30 is temporarily brought into contact with the optical semiconductor element 20 in the fourth embodiment, they need not always be brought into contact with each other. For example, the optical waveguide 30 may protrude outwards from the holding hole 11 toward the optical semiconductor element 20, and then be retracted to a predetermined position. In this case as well, a satisfactory air bubble removal effect can be obtained. Further, if no problem resulting from residual air bubbles is posed, the optical waveguide 30 need not always have to temporarily protrude from the holding hole 11. In this case, the optical waveguide 30 need only be inserted into the holding hole 11 up to a predetermined position.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical coupling element comprising:
an optical waveguide;
a ferrule provided with a holding hole configured to hold the optical waveguide, the ferrule having one opening of the holding hole, which opens on an element mounting surface of the ferrule, and the other opening of the holding hole;
an electrical read frame formed on the element mounting surface of the ferrule;
an optical semiconductor element which is mounted on the element mounting surface of the ferrule and connected to the electrical read frame, at least one side of the optical semiconductor element partially falling within a region obtained by extending the holding hole toward the optical semiconductor element; and
a transparent adhesive which fills a gap between the optical semiconductor element and one end of the optical waveguide.

2. The element according to claim 1, wherein
the holding hole includes a plurality of holding holes arrayed parallel in one direction, and
the optical semiconductor element is mounted across the plurality of holding holes, and one side of the optical semiconductor element in a longitudinal direction partially falls within each region obtained by extending each of the plurality of holding holes toward the optical semiconductor element.

3. The element according to claim 1, wherein an opaque resin covers the transparent adhesive present at a position at which the holding hole in the ferrule is not opposed to the optical semiconductor element.

4. The element according to claim 1, wherein the optical semiconductor element includes one of a light-emitting element and a light-receiving element, and the element mounting surface of the ferrule is tilted with respect to an optical waveguide direction of the optical waveguide.

5. The element according to claim 1, wherein the optical semiconductor element includes a VCSEL including a plurality of electrodes and a laser exit aperture on a front side, and the electrodes of the VCSEL are connected to the electrical read frame via bumps so that the laser exit aperture is formed at almost the center of the optical waveguide.

6. The element according to claim 1, wherein the optical semiconductor element includes a VCSEL including a plurality of electrodes and a laser exit aperture on a front side, some of the electrodes surround the laser exit aperture, and one side of the optical semiconductor element is adjacent to the laser exit aperture within a range in which the one side does not come into contact with the electrodes which surround the laser exit aperture.

7. The element according to claim 1, wherein the optical semiconductor element includes a PD including a plurality of electrodes and a light-receiving surface on a front side, some of the electrodes surround the light-receiving surface, and one side of the optical semiconductor element is adjacent to the laser exit aperture within a range in which the one side does not come into contact with the electrodes which surround the light-receiving surface.

8. The element according to claim 2, wherein the optical semiconductor element is formed by arraying VCSELs in one direction, and a distance between the VCSELs is equal to a distance between the holding holes.

9. The element according to claim 1, wherein the holding hole is formed by a main hole configured to hold the optical waveguide, and an auxiliary hole connected to the main hole, and the auxiliary hole partially falls outside the optical semiconductor element.

10. The element according to claim 1, wherein the holding hole is one of circular cross section and square cross section.

11. A method of manufacturing an optical coupling element, comprising:
preparing a ferrule provided with a holding hole configured to hold an optical waveguide, the ferrule having one opening of the holding hole, which opens on an element mounting surface of the ferrule, and the other opening of the holding hole, and the ferrule including an electrical read frame formed on the element mounting surface;
mounting an optical semiconductor element on the element mounting surface of the ferrule so that at least one side of the optical semiconductor element partially falls within a region obtained by extending the holding hole in the ferrule toward the optical semiconductor element;
filling the holding hole in the ferrule with a transparent adhesive while the optical semiconductor element is mounted on the element mounting surface of the ferrule;
inserting the optical waveguide into the holding hole in the ferrule from the opening on a side opposite to the element mounting surface so that a distal end of the optical waveguide protrudes outwards from the element mounting surface of the ferrule, while the holding hole is filled with the transparent adhesive; and
retracting, to a predetermined position, the optical waveguide protruding outwards from the element mounting surface of the ferrule.

12. The method according to claim 11, wherein in inserting the optical waveguide into the holding hole in the ferrule, the distal end of the optical waveguide is temporarily brought into contact with the optical semiconductor element.

13. The method according to claim 12, wherein the holding hole in the ferrule is further filled with an additional transparent adhesive so as to cover the transparent adhesive while the distal end of the optical waveguide is kept in contact with the optical semiconductor element.

14. The method according to claim 11, wherein the transparent adhesive is filled from the opening of the holding hole, which is on a side opposite to the element mounting surface.

15. The method according to claim 11, wherein the transparent adhesive is filled from the opening of the holding hole, which is on a side of the element mounting surface.

16. The method according to claim 11, wherein after the optical waveguide is retracted to the predetermined position, an opaque resin is applied so as to cover the transparent adhesive which is present at a position at which the holding hole in the ferrule is not opposed to the optical semiconductor element.

17. The method according to claim 11, wherein a thermosetting resin is used as the transparent adhesive, and is cured by performing a heat treatment after the optical waveguide is retracted to the predetermined position.

18. The method according to claim 11, wherein the optical semiconductor element includes a plurality of electrodes and a light exit aperture on a front side, and bumps are formed on the electrodes and bonded to the electrical read frame of the ferrule by thermocompression so as to mount the optical semiconductor element on the ferrule.

19. A method of manufacturing an optical coupling element, comprising:
preparing a ferrule provided with a holding hole configured to hold an optical waveguide, the ferrule having one opening of the holding hole, which opens on an element mounting surface of the ferrule, and the other opening of the holding hole, and the ferrule including an electrical read frame formed on the element mounting surface;
mounting an optical semiconductor element on the element mounting surface of the ferrule so that at least one side of the optical semiconductor element partially falls within a region obtained by extending the holding hole in the ferrule toward the optical semiconductor element;
filling the holding hole in the ferrule with a transparent adhesive while the optical semiconductor element is mounted on the element mounting surface of the ferrule; and
inserting the optical waveguide into the holding hole in the ferrule up to a predetermined position from the opening on a side opposite to the element mounting surface so that a distal end of the optical waveguide protrudes outwards from the element mounting surface of the ferrule, while the holding hole is filled with the transparent adhesive.

20. The method according to claim 19, wherein a thermosetting resin is used as the transparent adhesive, and is cured by performing a heat treatment after the optical waveguide is retracted to the predetermined position.
